(19) United States
(12) Patent Application Publication
(10) Pub. No.: US 2023/0025712 A1
(43) Pub. Date: Jan. 26, 2023

(54) METHOD OF STABLE LASSO MODEL STRUCTURE LEARNING TO BUILD INFERENTIAL SENSORS

(71) Applicant: CITY UNIVERSITY OF HONG KONG, Kowloon (HK)

(72) Inventors: Si-Zhao QIN, Kowloon (HK); Yiren LIU, Kowloon (HK)

(21) Appl. No.: 17/374,563

(22) Filed: Jul. 13, 2021

(51) Int. Cl. G06N 7/00; G06K 9/62

(52) U.S. Cl. CPC G06N 7/005; G06K 9/6202; G06K 9/6227; G06K 9/6261; G06K 9/6262

(57) ABSTRACT

A stabilization method and mechanism for model structure learning is described. A model is built based on a full data set. The full data set is partitioned into cross validation (CV) folds. A set of model structures of the model are cross validated for each CV fold while penalizing structural deviations from the model to determine CV errors. A model structure is selected from the set of model structures based on a comparison of CV errors with an industrial data set.

### TECHNICAL FIELD OF THE INVENTION

The present invention relates to machine learning methods for producing inferential sensors for monitoring industrial processes, including the prediction and estimation of emissions, quality, and key performance indicators.

Furthermore, the current disclosure relates to mechanisms for implementing machine learning, for stabilizing least absolute shrinkage, and for selecting operator (Lasso) and/or Lasso family based models that employ cross validation (CV) as part of regularization.

### BACKGROUND

Process data analytics are gaining wide acceptance in the monitoring, interpretation, and prediction of product quality, and also in diagnosis of industrial processes. The main objectives of process data analytics are i) to identify the critical input variables that can be used to predict the product quality or process outcome, and ii) to select relevant features or variables for interpretation.

Inferential sensors are mathematical models based on such critical product or process variables, and may be used in place of actual physical sensors. When building an inferential sensor, therefore, the task includes identifying the critical variables by using a set of process predictor variables. However, although inferential sensors are popularly applied in many industrial fields and have been an active research topic for several decades, the task of selecting relevant predictor variables has remained ad hoc and little studied.

In recent years, structured learning via sparse statistical learning has provided a plethora of promising solutions to the task of selecting the variables. For example, sparse statistical learning methods such as Least Absolute Shrinkage and Selection Operator (Lasso) provide effective ways for identifying subsets of variables that are among the best for predicting or interpreting the product or process outcome. Selecting predictive variables via sparse methods often leads to biased models, but they also often outperform their unbiased counterparts, especially when the selected variables are diverse and inter-dependent. In other words, these methods forego the interest to estimate the true model coefficients. Instead, the objective is to determine whether or not a variable would help model interpretation or prediction in the sense of the mean squared error (MSE).

The method of Lasso can include tuning a regularization parameter denoted as λ, called the regularization penalty. Lasso may use cross-validation (CV) to select the optimal λ. The method includes repeated iterations through different values of λ. Firstly, a set of training data is divided into multiple folds. A grid of λ values can be chosen and the cross-validation error can be calculated for each value of λ. Second, the tuning parameter value can be picked for which the cross-validation error is smallest. Finally, the model can be re-trained on all training data with the selected λ.

In industrial situations, process data can be collinear due to material and energy balances and operation safety requirements. With collinearity present in the data, sparse regression methods such as Lasso often lead to seemingly different sets of selected variables with minor perturbation of the training data. However, the process may not have changed. This happens when the active l₁ constraint is nearly collinear with the contour of the objective function, resulting in solutions that swing between different vertices of the constraints. As an improved method, elastic nets blend an l₂ norm penalty in the Lasso l₁ penalty. But this approach does not resolve the stability problem. In practice, the stability issue due to changes in the training data can be confusing to the practitioners, especially when the models are updated with new data.

The instability of Lasso due to variations in training samples presents a cumbersome issue when cross-validation is used to select the optimal penalty λ. For different folds of training samples in multi-fold CV, the selected variables can be very different for the same λ value. Therefore, the λ of the minimum MSE is averaged from models with seemingly different selected variables. One may question what it means to average across these models with heterogeneous structures. Furthermore, the final model structure selected using all data can be very different from the model structures used in each fold of CV.

In the field of disease prediction and diagnosis for example, Lasso is unstable in the presence of correlated features. This behavior presents problems for biomedical applications, hindering clinic application of Lasso, as multiple collinear data is often hidden in biomedical observations.

Therefore, it is desirable to propose a method that provides the benefits of predicting contributing factors of Lasso but with which the instability problem due to correlated data is mitigated. Such a stable method may be useful also in credit risk prediction for financial institutions where accurate knowledge discovery is needed.

### SUMMARY OF THE INVENTION

The proposed method is a stabilization strategy for Lasso when using CV (cross-validation) for structured learning. This method possibly reduces heterogeneity of model structures used during CV.

Basically, the proposed method reverses the procedure of standard CV for Lasso by building models with a grid of λ using all data first. Then the model structures for each CV fold are driven towards the model structure using all data by using a revised Lasso objective that penalizes deviations from the model structure using all data. Further, the optimal CV errors as defined by mean square errors (MSE) and median squared errors (MdSE) are compared with industrial data sets.

### BRIEF DESCRIPTION OF DRAWINGS

For a more complete understanding of the present disclosure and the advantages thereof, reference is now made to the following brief description, taken in connection with the accompanying drawings and detailed description, wherein like reference numerals represent like parts.

FIG. 1 shows an example of an industrial boiler process with NOₓ emission monitoring.

FIG. 2 shows an example of scatter charts for NOₓ versus nine process variables of the boiler data.

FIG. 3 shows a graph of an example of a range of λ for the cross validated MSE of Lasso.

FIG. 4 shows a graph of an example of the number of non-zero coefficients for the cross validated MSE of Lasso.

FIG. 5 shows an example of selected variables in each CV fold in a CV Lasso.

FIG. 6 shows a graph of an example of a range of λ for a seven fold CV MSE of Stable Lasso.

FIG. 7 shows a graph of an example of the number of non-zero coefficients for the seven fold CV MSE of Stable Lasso.

FIG. 8A shows an example of selected variables in each CV fold in the Stable Lasso.

FIG. 8B shows an example of selected variables for all training data.

FIG. 9 shows a graph of an example of the cross validated MSE, median MSE, and the number of non-zero coefficients versus λ for Stable Lasso.

FIG. 10 shows an example of the JSM stability indices for Stable Lasso and Lasso among seven CV folds.

FIG. 11 shows examples of correlations and actual vs. predicted values on 20% test data with λ values selected by minimum MSE, minimum MdSE, and the Stable Lasso.

FIG. 12 shows graphs of an example of regression coefficients of Stable Lasso.

FIG. 13 shows graphs of an example of regression coefficients of Lasso.

FIG. 14 shows an example of process diagram that produces a challenge dataset.

FIG. 15 shows an example of variables selected by Lasso for a range of λ using all training data from the challenge data.

FIG. 16 shows a graph of an example of cross validated MSEs for the seven folds of Stable Lasso.

FIG. 17 shows a graph of an example of cross validated MSEs for the seven folds of Stable Lasso.

FIG. 18 shows an example of variables selected or un-selected by Stable Lasso in each CV fold.

FIG. 19 shows an example of variables selected or un-selected by Lasso in each CV fold.

FIG. 20 shows a graph of an example JSM stability index for Stable Lasso and Lasso for the seven CV folds and an example of the coefficients of the model by the stable selection criterion.

FIG. 21 depicts an example of the coefficients of the model by the stable selection criterion and those based on CV MSE.

FIG. 22A and FIG. 22B depict an example of scatter plots and correlations of actual vs. predicted values on the training dataset with R² values selected by minimum MSE, minimum MdSE, and the stable Lasso for the validation dataset.

FIG. 23 is a schematic diagram of an example computing device configured to perform the example mechanisms described herein.

FIG. 24 is a flowchart of an example method of stabilization enhanced CV for Lasso models for selection of predictive variables.

FIG. 25 provides results of selected variables of lasso for training DOW data.

FIG. 26 shows the optimal μ selection by cross-validation.

FIG. 27 with the optimal μ, the model derived from the final ridge regression based on all training data gives R2 and Q2 results is shown in rightmost panel;

FIG. 28 with the optimal μ, the model derived from the final ridge regression based on all training data gives R2 and Q2 results is shown in rightmost panel; and

FIG. 29 shows coefficients for Stable Lasso l-r method and standard lasso method.

### DETAILED DESCRIPTION

Lasso is a method of regression analysis used in machine learning to preform predictions based on sparse data. In an industrial process where there are too many variables for human operators to analyse, Lasso is can be used to select or identify the process variables that contribute significantly to the process output and are therefore most predictive. Lasso also performs regularization, which mitigates model overfitting. In practice, overfitting is associated with the noise data that is due to an excessive number of model parameters.

Cross-validation (CV) is a method for estimating the accuracy of a predictive model, and is able to determine if there are issues such as overfitting and/or selection bias. CV is basically an iteration which reapplies the same data set repeatedly for every change of λ, the tuning parameter, to reveal the best fit in Lasso and Ridge regressions. Every change of λ requires an iteration of cross-validation, during which the full set of data is divided into a training set and validation set (called a fold). Each training set is used to propose a model and the respective validation set to evaluate accuracy that model. Different iteration uses different apportionments of the same data so that all training sets and respective test sets are different. The CV process considers the accuracy of the trained model with respect to the validation set to estimate the particular model's predictive performance.

CV may result in poor performance when used as part of regularization in Lasso. In particular, CV can be employed to determine the ultimate value for λ. λ may be used as a regularization term which penalizes model complexity. However, cross-validation tends to select dense structures by using an excessive number of variables. This is because cross-validation uses a very small increments of λ to approach the ultimate λ. This problem is particularly severe in the presence of collinear variables, which are common in industrial data analytics. While a small λ leads to marginal improvements in the MSE or MdSE, it is often outweighed by having to process an excessively large number of collinear variables, which is also in a less stable region of λ.

To overcome this problem, it is proposed herein to select only stable models. which have near-minimum CV errors, by using CV errors and a stability measure.

Therefore, the embodiment herein is a stabilization mechanism that employs CV to stabilize Lasso and Lasso family related models. In an example, the stabilization mechanism may be used to reduce the heterogeneity of model structures during CV. The stabilization mechanism builds a series of models with a grid of λ′s using an entire data set. The stabilization mechanism penalizes structural changes for each model at each CV fold using the entire data set. A CV fold is a repartition of data into training and validation sets. CV errors, as determined by MSE and/or MdSE, for each model can be compared with one or more industrial data set. Further, λ can be selected based on the CV errors and a stability measure.

Lasso stability in the presence of collinearity is now discussed. Suppose xₖϵR^{P} are predictor variables and yₖ is the response variable to be predicted from the values of xₖ. Assume further that these variables are scaled to zero mean and unit variance based on N observations. Relevant variables can be selected and the regression coefficients can be estimated based on the following equation:

yₖ=β₀−xₖ^{T}β+εₖ (1)
where β₀=0 if both xₖ and yₖ are scaled to zero mean.

The Lasso approach applies constraints to the least squares objective as follows:

$${min}_{β , {β}_{0}} \frac{1}{2 N} {\sum }_{k = 1}^{N} {( {y}_{k} - {β}_{0} - {x}_{k}^{T} β )}^{2} s . t . {‖ β ‖}_{1} \leq t \qquad ( 2 )$$

where t is a tuning parameter to make the constraint active so as to shrink the l₁ norm of the estimated coefficients β.
   With the constraint active, the resulting dual problem is as follows based on the Karush-Kuhn-Tucker condition,

$${β}_{λ}^{N} = arg {min}_{β , {β}_{0}} \frac{1}{2 N} {\sum }_{k = 1}^{N} {( {y}_{k} - {β}_{0} - {x}_{k}^{T} β )}^{2} + λ {‖ β - {β}_{λ}^{N} ‖}_{1} \qquad ( 3 )$$

where λ is the Lagrangian multiplier that has a one-to-one correspondence to t.

In practice, λ is a tuning parameter which is usually determined by CV. CV builds models based on multiple folds of the training data and selects λ to yield the minimum validation error of the data not used in training the corresponding model. Each λ usually leads to a subset of the regression coefficients to be zero to enable variable selection.

The solution of each model corresponds to a vertex of the active constraint set. However, if the input data are collinear, the contours of the objective function (2) are elongated ellipses. If the elongated ellipses are parallel to the l₁ constraint in (2), minor changes in the data can alter the Lasso solution from one vertex to another. Consequently, the selected variables set can change significantly while to objective value is little changed. These changes indicate the instability of Lasso solutions, which is not desirable for interpretation, decision making, and knowledge extraction.

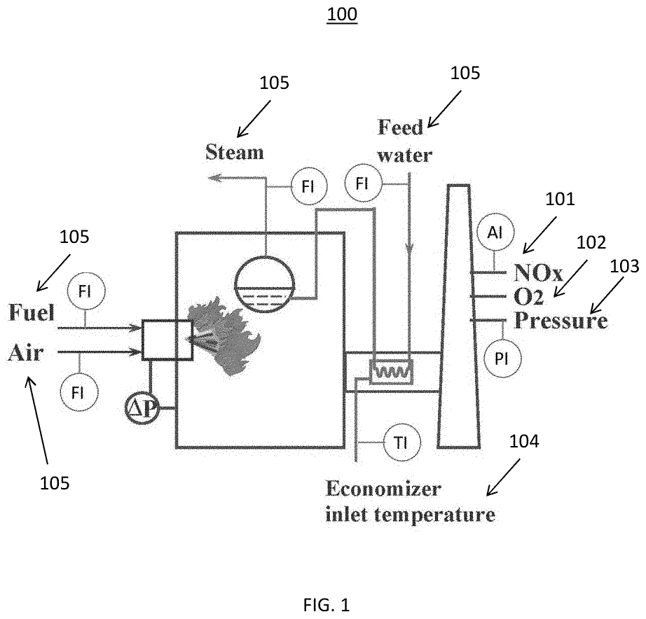

The process can be illustrated with respect to an example. FIG. 1 shows an example of an industrial boiler process 100 with NOₓ emission monitoring. Typically, NOx emissions 101 from the boiler process 100 is measured with an analytical instrument. Process sensors, including low rate sensors 105, pressure sensors 103, temperature sensors 104, and oxygen composition sensors 102, are also installed for other operation purposes. All these equipment are very expensive and could be replaced by an inferential sensor that has been trained using Lasso regression, to produce reliable and accurate predictions of NOx emission 101.

That is, the purpose of the regression modeling is to identify and select relevant variables read from the sensors to predict the NOx emission 101 level from the boiler process 100. In this example, nine process variables are candidate predictors and the NOx measured at the top of the stack is the response variable. Not all nine variables will have significant contribution to the NOx output. A couple or more of these variables may be so collinear that only the most suitable one of these variables may be used in a predictive model without upsetting the prediction.

If a reliable predictive model can be trained from the data records of these variables, the model can be permitted by environmental regulations to replace hardware analytical sensors with the inferential ones. Thus, the predictive inferential sensors can omit the costs associated with the expensive hardware sensors.

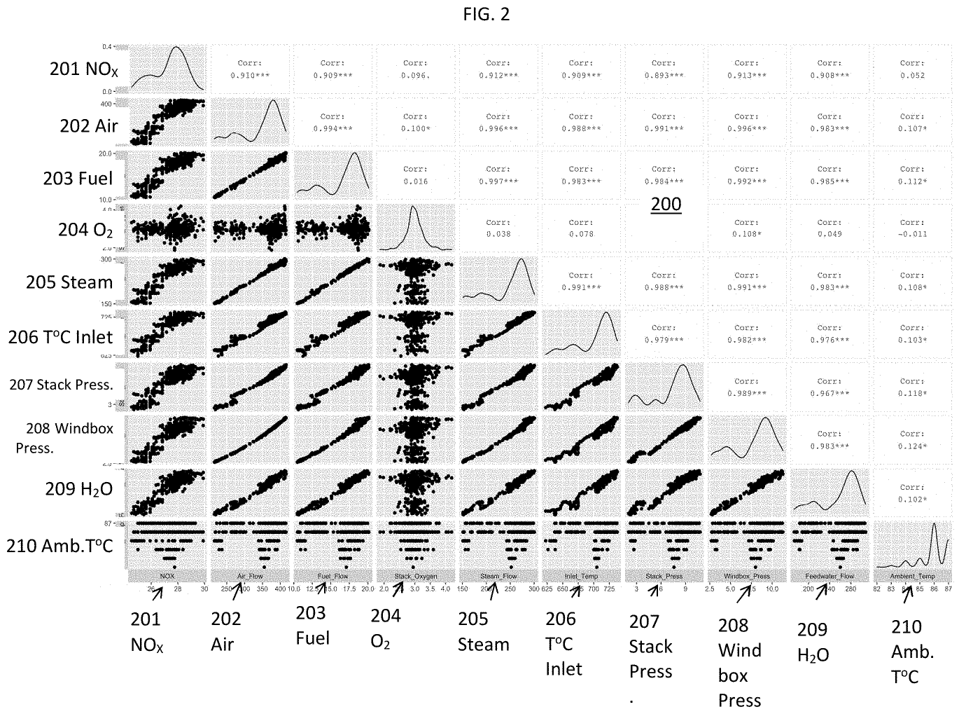

FIG. 2 shows an example of scatter charts 200 for NOₓ 201 versus nine process variables of the boiler data. The bottom of FIG. 2 marks each of the columns as related to Air Flow 202, Fuel Flow 203, Stack Oxygen 204, Steam Flow 205, Inlet Temperature 206, Stack Pressure 207, Windbox Pressure 208, Feedwater Flow 209, and Ambient Temperature 210.

Boiler data collinearity can be seen in FIG. 2. FIG. 2 is a set of correlation charts between any two of the variables. From the leftmost column, NOx 201 can be seen to have positive correlations with most of the process variables (the best fit line appears to slant upward from left to right in all the charts in the left-most column). However, there is little dependence on Stack Oxygen 204, which shows a near horizontal scatter of data (7^{th} row from the bottom up in the left-most column), and Ambient Temperature 210, which shows no identifiable trend (bottom-most row in the left-most column). because they are under feedback control to narrow ranges.

The seven variables that have positive correlations to NOx 201 are highly collinear, as evident from the charts. In addition, correlations for Steam Flow 205 versus Air Flow 202 and Steam Flow 205 versus Fuel Flow 203 are close to 1.0 due to energy balances. The correlation between Air Flow 202 and Windbox Pressure 208 is also close to 1.0 with mild nonlinearity, which is due to the laws of fluid dynamics.

A seven-fold CV can be applied to the Lasso algorithm in order to test whether Lasso is stable in selecting model structures across different folds. To make sure the samples in each fold have similar distributions, the data is randomly sampled without replacement.

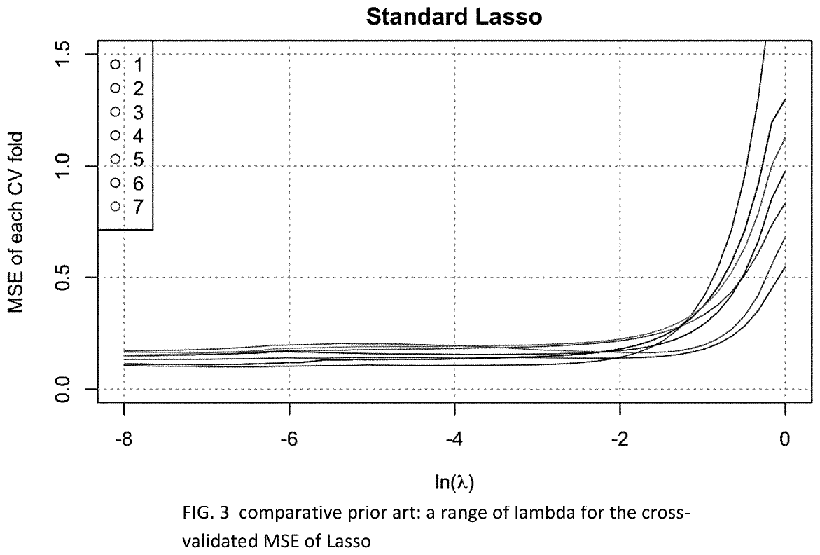

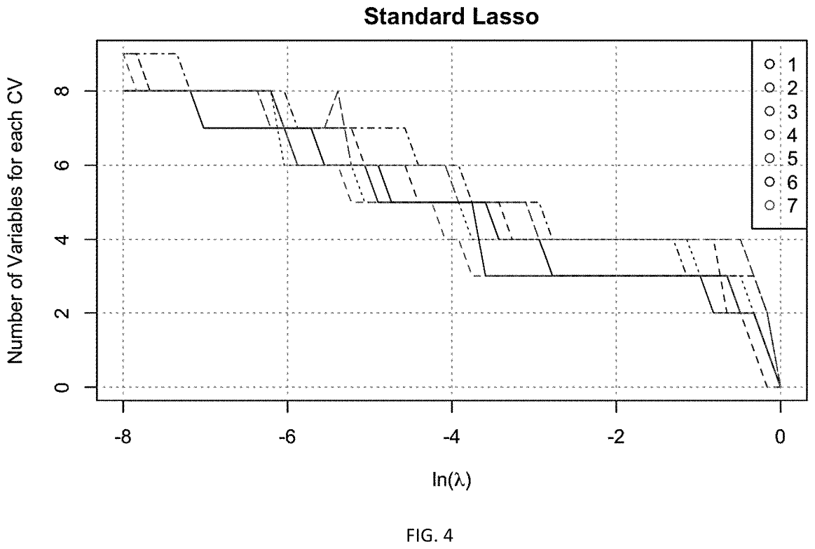

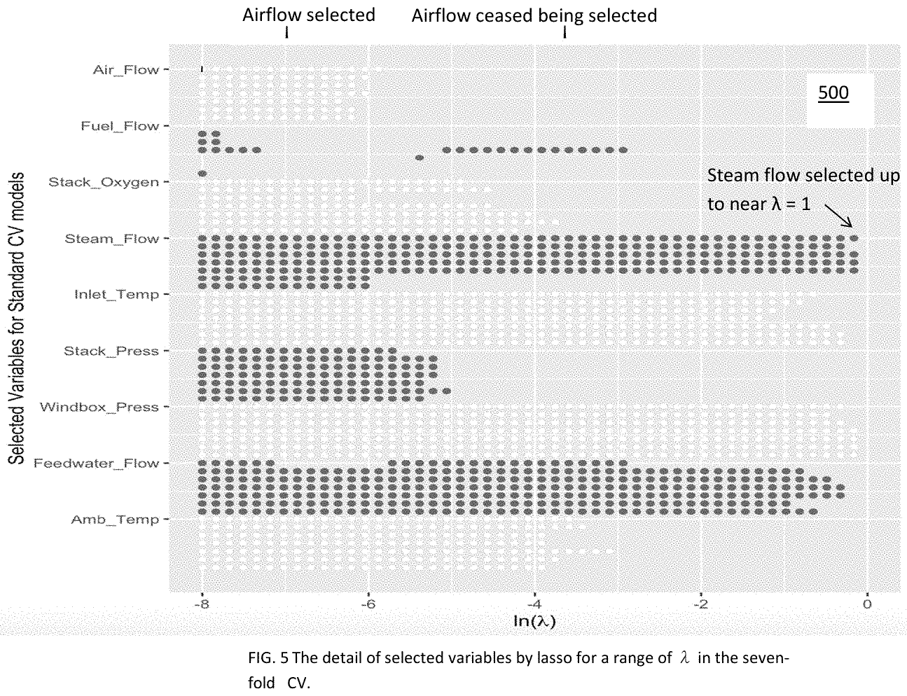

FIG. 3 shows a comparative prior art, which is a graph 300 of a range of λ for the cross validated MSE of Lasso. FIG. 4 shows a graph 400 of an example of the number of non-zero coefficients for the cross validated MSE of Lasso as shown in FIG. 3. FIG. 5 shows an example of selected variables 500 in each CV fold in a CV Lasso.

Various observations related to the stability of Lasso with CV can be made based on FIGS. 3-5. For example, Lasso tends to be unstable for collinear data. Although the MSEs from each CV fold are comparable, the variables selected in each fold can vary a lot, especially for smaller λ values. Further, if the models are updated in real-time with data, dropping or adding variables to the model without sensible improvement in the model quality, it can be confusing for the person studying the model. This could lead him to believe that the process has changed. However, such changes are actually due to high sensitivity to variations in the samples. In some regions, e.g., around log(λ)=−2, the number of variables selected across CV fold is more stable for a wide region of log(λ). This suggests that λ values that lead to more stable structures could be preferred over other values, if the model errors are comparable. In addition, the MSEs across each CV fold do not have symmetric distributions. Some MSEs can be outlying comparing to the others. This suggests that the MdSE could be a better alternative to the average of the MSEs.

A Stable Lasso method with CV of the invention is now discussed. The following algorithm can be used for selecting an optimal λ to improve the stability of structure learning using Lasso with cross-validation, while attaining near optimal CV errors.

First, all training data {xₖ}ₖ₌₁^{N} can be scaled to zero mean and unit variance.

Subsequently, all training data is used to estimate β_{λ}^{N}, according to Equation (3), for a range of λ that covers the optimal λ. β₀^{N}=0 due to the zero-mean scaling.

Second, the training data can be divided into an s number of folds to perform the CV.

The j^{th} CV model can be estimated using the training set Tⱼ with Nⱼ observations and the rest as the j^{th} validation set Vⱼ, where Tⱼ includes all observations except for Vⱼ.

The Stable Lasso objective is modified as follows.

$${β}_{λ}^{{N}_{J}} = arg {min}_{β} \frac{1}{2 {N}_{J}} {\sum }_{k ∈ {T}_{J}} {( {y}_{k} - {β}_{0} - {x}_{k}^{T} β )}^{2} + λ {‖ β - {β}_{λ}^{N} ‖}_{1} \qquad ( 4 )$$

The mean squared error is calculated on the validation set Vⱼ using β_{λ}^{N}^{ⱼ}.
In Equation (4) each λ calls for a corresponding β_{λ}^{N} to be used in the equation.

Third, the λ that gives the minimum MSE or the minimum MdSE is chosen as the optimal λ*. The corresponding coefficients β_{λ*}^{N} from the first step can be the selected model.

Fourth, to further improve stability, one can choose a stable region where the JSM (Jaccard stability measure, see below) is as close to one as possible, while the MSE and/or MdSE almost the same as their minimum values. This maximum possible JSM indicates that the model structure is highly stable across all CV folds. If, furthermore, the highest JSM value is obtained with multiple consecutive λ values, one can choose the most dominant structure among all distinct structures that attain the highest JSM value.

Fifth, to further improve accuracy, the final model parameters with the most dominant stable model structure obtained by the Fourth step is re-estimated with a cross-validated ridge regression objective as follows,

$${min}_{β} \frac{1}{N} {\sum }_{K = 1}^{N} {( {y}_{k} - {β}_{0} - {x}_{k}^{T} β )}^{2} + μ {‖ β ‖}^{2}$$

where the hyperparameter μ is optimized via cross-validation.
   The improved approach of using objective Equation (4) and the above ridge regression provides a balanced selection criterion between MSE and stability, which is referred to as the Stable Lasso approach herein.

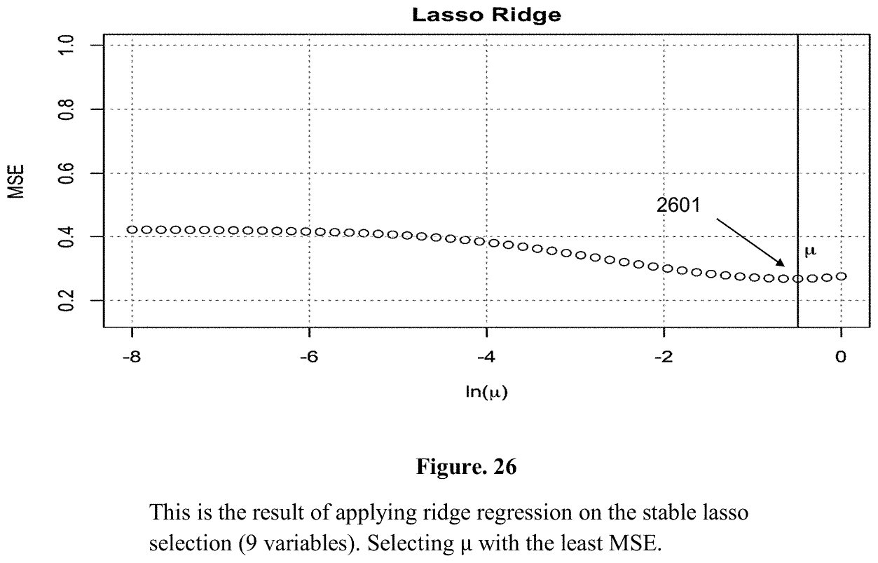

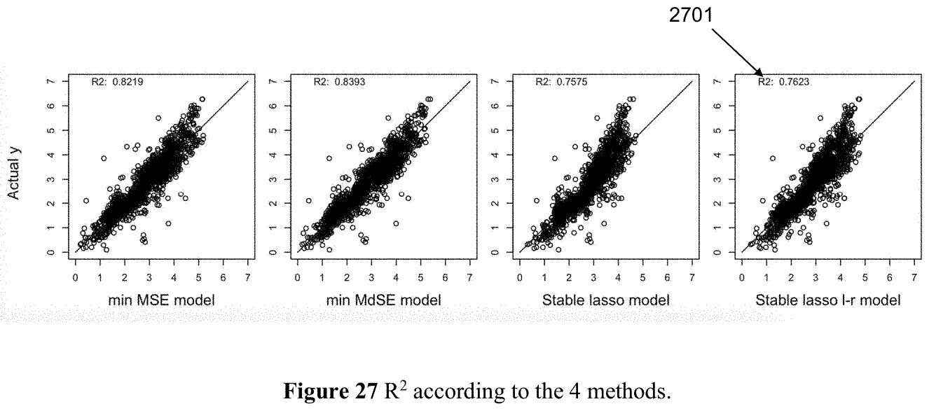

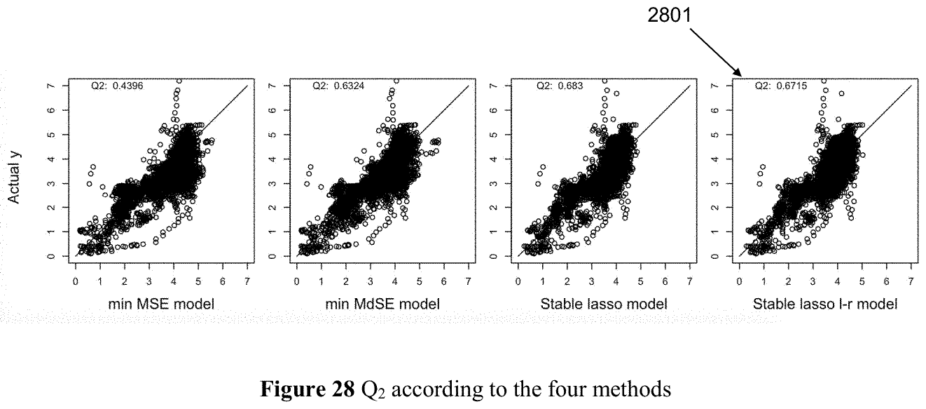

FIG. 26 shows the optimal μ 2601 selection by cross-validation. With the optimal μ 2601, the model derived from the final ridge regression based on all training data gives R2 2701 and Q2 2801 results in the rightmost panels of FIGS. 27 and 28, respectively.

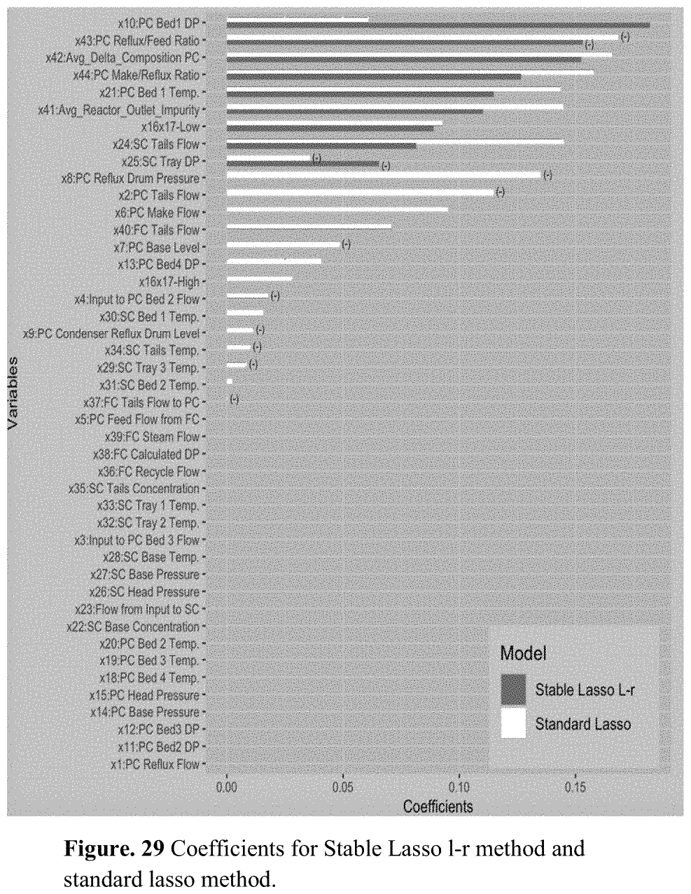

The model parameters by a final ridge regression on all data using the structure selected via the Stable Lasso is given in FIG. 29. The Stable Lasso identifies less predictor 2091 than the Standard Lasso 2093.

The Stable lasso algorithm regularizes the CV models towards the Lasso model based on all training data. For zero entries in β_{λ}^{N}, the Stable Lasso pulls these entries in each CV model towards zero. Therefore, the algorithm prefers to keep them zero unless the subset of the CV data strongly disagrees.

The objective Equation (4) is equivalent to the following Lasso equation:

$$δ {β}_{λ}^{{N}_{J}} = arg {min}_{δ β} \frac{1}{2 {N}_{J}} {\sum }_{K ∈ {T}_{J}} {( δ {y}_{k} - {β}_{0} - {x}_{k}^{T} δ β )}^{2} + λ {‖ δ β ‖}_{1}$$

where δyₖ=yₖ−xₖ^{T}β_{λ}^{N} and β_{λ}^{N}^{_{J}}=δβ_{λ}^{N}^{_{J}}+β_{λ}^{N}.

The CV objective Equation (4) in Stable Lasso can be interpreted as a Bayesian Lasso which uses β_{λ}^{N} as the mean value of the Laplace prior. The Bayesian Lasso uses a prior distribution that characterizes the belief in what their values might be. The model for this Bayesian interpretation is

$$y \vert β , {λ}^{′} , σ \sim N ( X β , {σ}^{2} {I}_{N \times N} ) \qquad ( 5 )$$

$$β \vert {λ}^{′} , σ \sim {\prod }_{i = 1}^{p} \frac{{λ}^{′}}{2 σ} {e}^{- \frac{{λ}^{′}}{σ} \vert β i - {β}_{λ , i}^{N} \vert} \qquad ( 6 )$$

where λ′ differs from λ by a scaling constant.
   The negative log posterior density for β|λ′, σ is

$$\frac{1}{2 {σ}^{2}} {\sum }_{K ∈ {T}_{J}} {( {y}_{k} - {β}_{0} - {x}_{k}^{T} β )}^{2} + \frac{{λ}^{′}}{σ} {‖ β - {β}_{λ}^{N} ‖}_{1}$$

which is equivalent to Equation (4).

In Equation (4), there is an option to make the l₁ penalty on the zero entries of β_{λ}^{N} only. This option leaves the non-zero entries of β_{λ}^{N} un-penalized and no more sparsity is needed from them. This option could be implemented with a group-Lasso.

The Jaccard stability measure (JSM) can be used to quantify stability. JSM is defined as the average of Jaccard indices over each pair of CV selected variable sets, which is

$$JSM = \frac{2}{s ( s - 1 )} {\sum }_{i = 1}^{s - 1} {\sum }_{j = i + 1}^{s} J ( {S}_{i} , {S}_{j} ) where \\ J ( {S}_{i} , {S}_{j} ) = \frac{\vert {S}_{i} ⋂ {S}_{j} \vert}{\vert {S}_{i} ⋃ {S}_{j} \vert} \qquad ( 7 )$$

JSM being 1.0 indicates consistent model structures across all CV folds, while J(Sᵢ, Sⱼ)=1.0 indicates that Sets Sᵢ and Sⱼ include the same variables.

The following describes application of the Lasso mechanisms to the industrial boiler data as shown in FIG. 2. For example, the industrial boiler data has 390 observations sampled at a 5-minute interval. Since industrial operation data usually change steadily over time, the CV folds are carefully divided. 175 is chosen to divide the data into consecutive blocks of five observations for each block. The blocks for CV subset folding are then randomized. Only 80% of all data are used to select λ; the remaining 20% of data are reserved for testing the structure learning results.

Example Stable Lasso results are now described. A seven-fold CV can be implemented for the Stable Lasso algorithm to test selection of model structures across different CV samples.

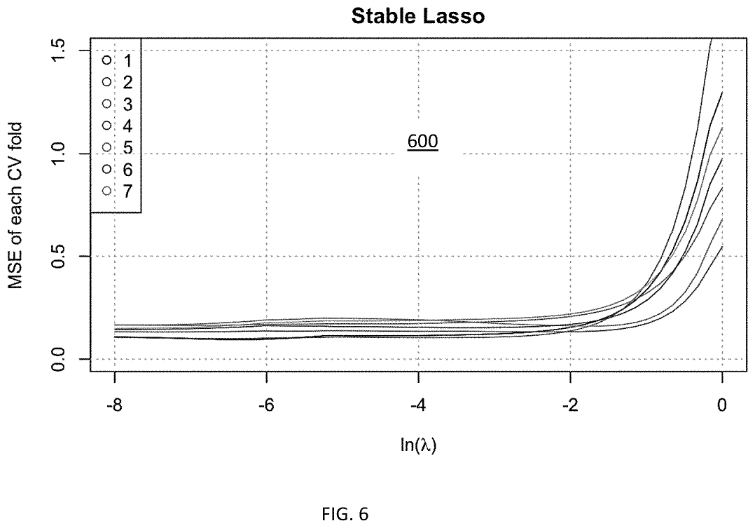

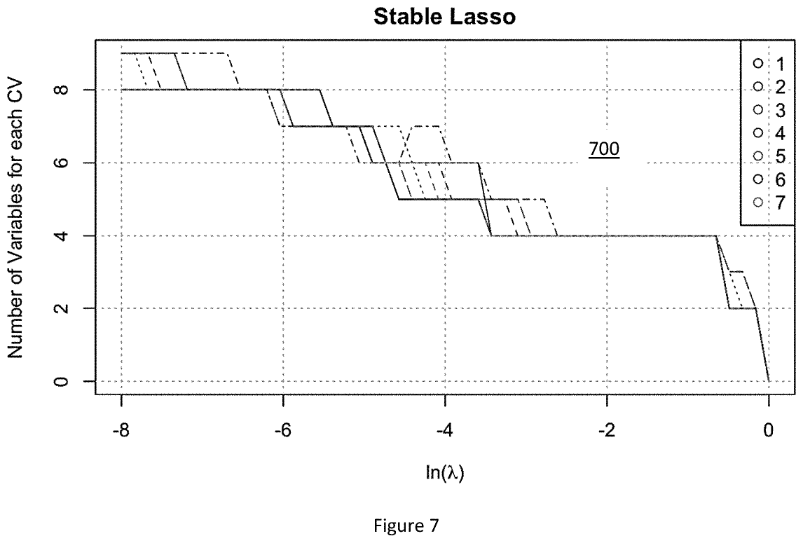

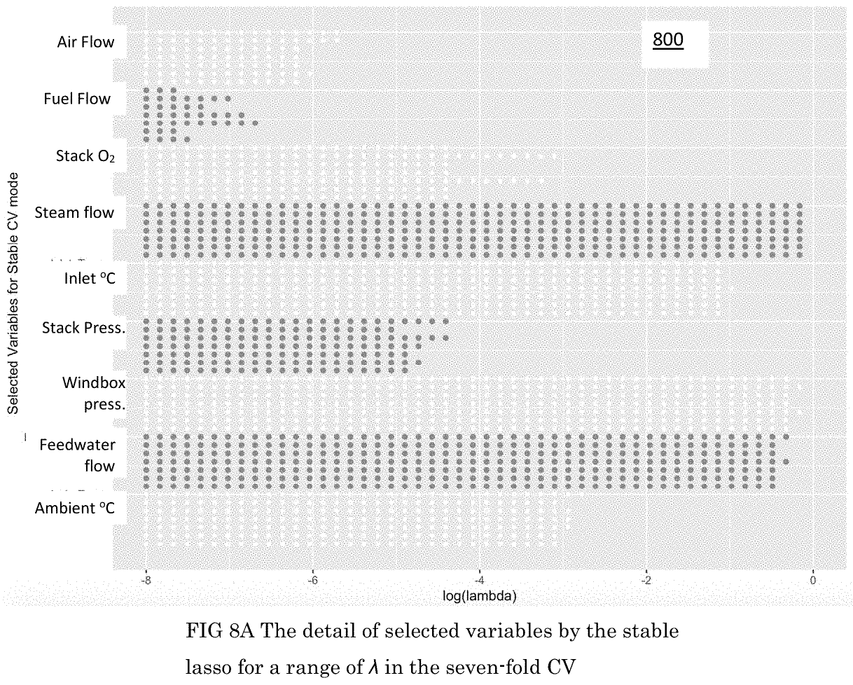

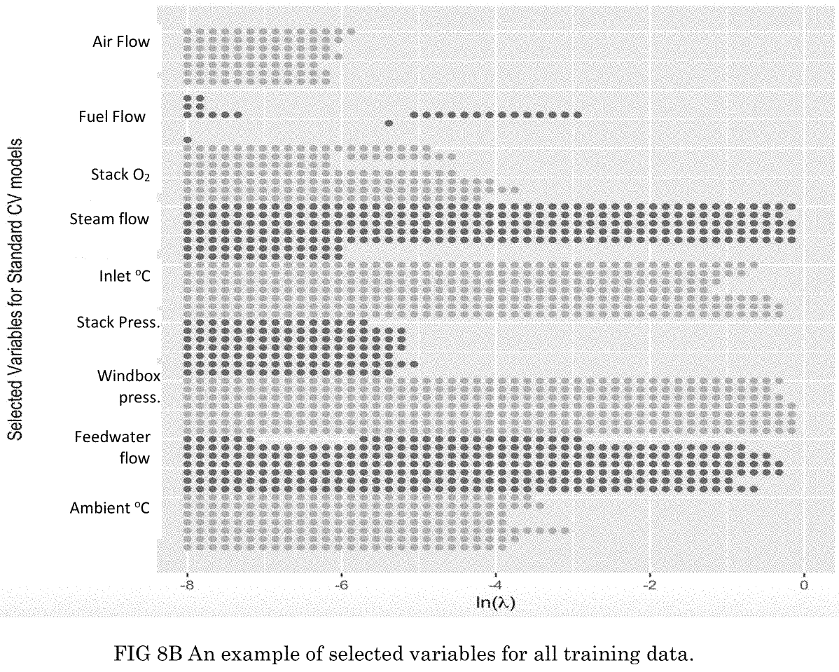

FIG. 6 shows a graph 600 of an example of a range of λ for a seven fold CV MSE of Stable Lasso. FIG. 7 shows a graph 700 of an example of the number of non-zero coefficients for the seven fold CV MSE of Stable Lasso. FIG. 8A shows an example of selected variables 800 in each CV fold in the Stable Lasso. FIG. 8B shows an example of selected variables for all training data.

Comparing the results in FIGS. 6-8 for the Stable Lasso to those in FIGS. 3-5 for the Lasso, the stability in the number of selected variables in CV is much improved, while the CV MSEs are little affected. The detail of selected variables of each CV fold in FIG. 8A shows consistent structures across CV folds for nearly all λ values.

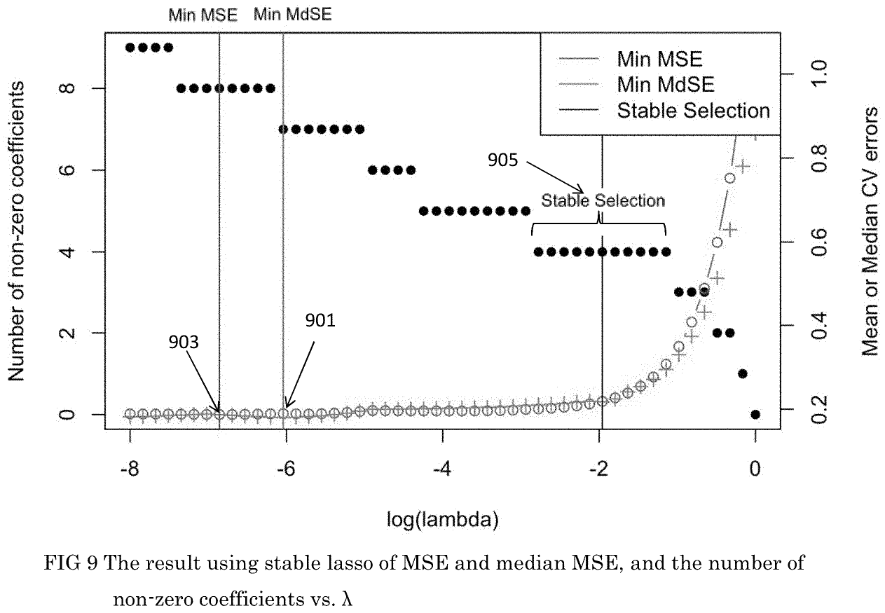

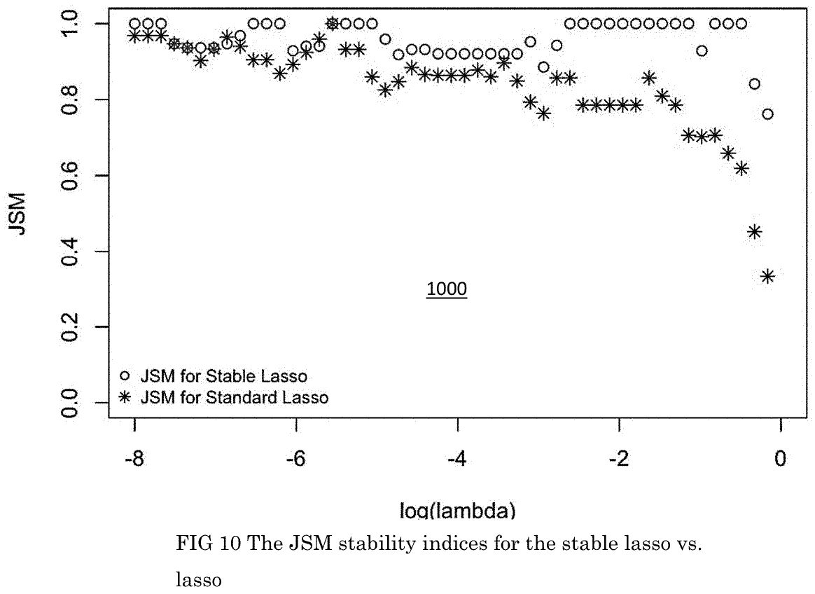

FIG. 9 shows a graph 900 of an example of the cross validated MSE, median MSE, and the number of non-zero coefficients versus λ for Stable Lasso. FIG. 9 also shows the λ values selected by minimum MSE 901, minimum MdSE 903, and the Stable Lasso. FIG. 10 shows a graph 1000 of an example of the JSM stability indices for Stable Lasso and Lasso among seven CV folds.

The Stable Lasso selection finds a region of λ which is most stable, while keeping the MSE and MdSE near their minimum values. The Stable Lasso selection yields 1.0 for JSM, which indicates perfect consistency in model structures across all CV folds. To test how well these selections of λ affect the model prediction accuracy, the Lasso models are applied with these λ values to the 20% test data that is reserved for model testing.

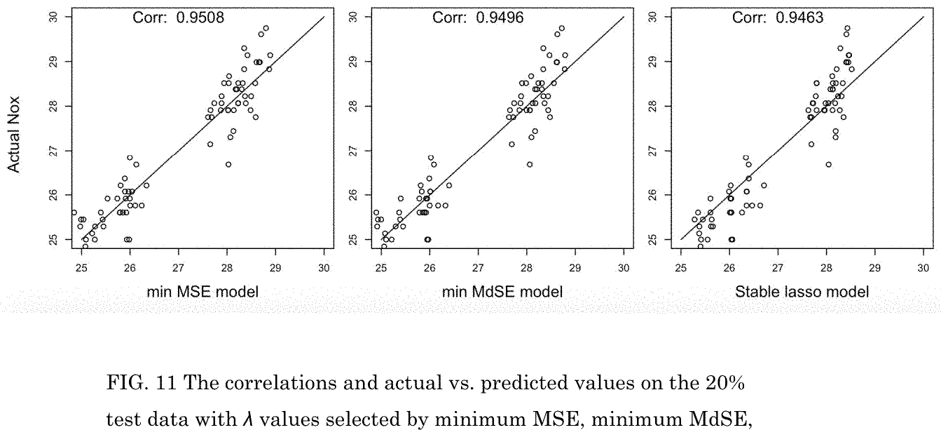

FIG. 11 examples of correlations and actual vs. predicted values on 20% test data with λ values selected by minimum MSE, minimum MdSE, and the Stable Lasso. The preceding figures clearly show that the Stable Lasso produces nearly the same model accuracy, while selecting λ values based on the minimum MSE or minimum MdSE alone is much less stable. The Lasso MSEs of one CV fold are quite different from the rest, indicating heterogeneity across the CV models. This situation is improved in the case of Stable Lasso due to the application of the stability cost.

Model validation with first principles is now described. The three models yield similar accuracy for the test data, and one of them produces physically interpretable results. Table 1, as shown below, contains regression coefficients for the boiler process data using the optimal λ selected by minimum MSE, minimum MdSE, and Stable Lasso, respectively.

TABLE 1

| Variable | min MSE | min MdSE | JSM & Stable Lasso |
|---|---|---|---|
| Air Flow | −1.3884 | −0.2712 | 0 |
| Fuel Flow | 0 | 0 | 0 |
| Stack Oxygen | 0.1257 | 0.065 | 0 |
| Steam Flow | 1.6945 | 0.8022 | 0.0559 |
| Inlet Temperature | 0.0821 | 0.1329 | 0.1531 |
| Stack Pressure | −0.7085 | −0.5934 | 0 |
| Windbox Pressure | 1.2155 | 0.8296 | 0.4528 |
| Feedwater Flow | 0 | 0 | 0.1611 |
| Ambient | −0.0637 | −0.0583 | 0 |
| Temperature | | | |

As shown above, the models selected by minimum MSE and minimum MdSE have negative coefficients on Stack Pressure and Air Flow. However, these variables have positive correlations to the response NOx. Therefore, although the models yield similar accuracy, they result in regression coefficients with erroneous signs due to collinearity. On the other hand, the Stable Lasso method leads to positive coefficients on four selected variables, which is consistent with the process mechanism. Among the four selected variables, Steam Flow is the load of the boiler which is definitely a critical variable. Windbox Pressure and Feedwater Flow maintain the energy and mass conservation to produce the Steam Flow. The Economizer Inlet Temperature is selected due to relation to the energy to produce the Steam load. However, the Inlet Temperature coefficient is very small compared to the others.

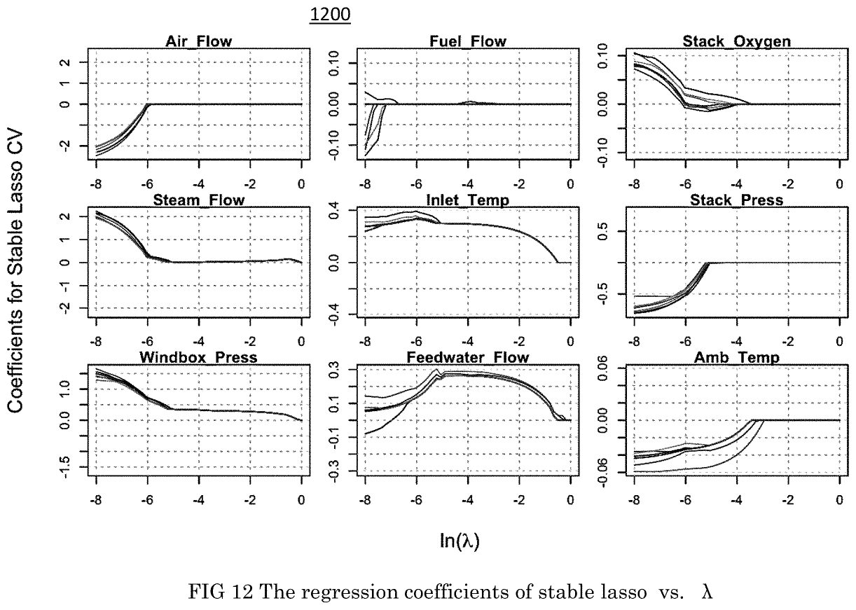

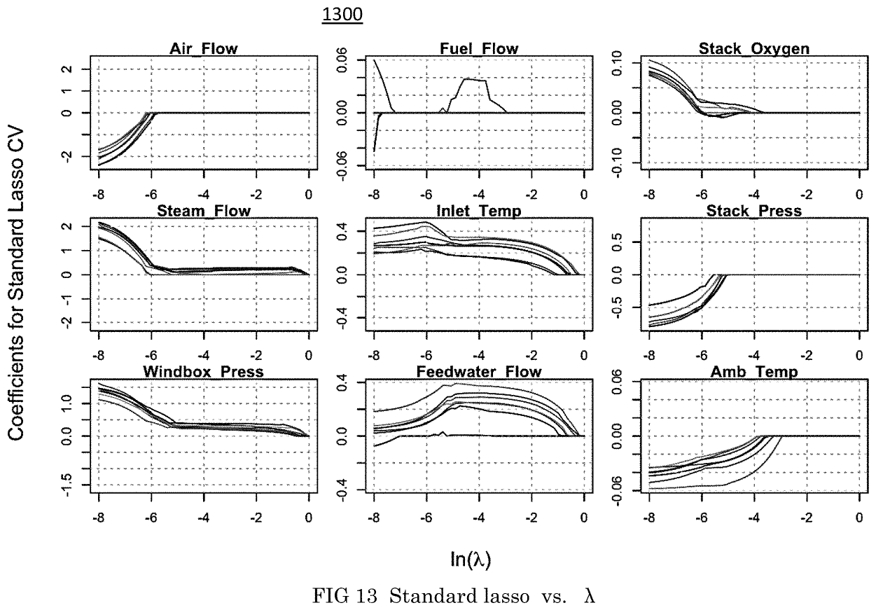

FIG. 12 shows graphs 1200 an example of regression coefficients of Stable Lasso. FIG. 13 shows graphs 1300 an example of regression coefficients of Lasso. As shown in FIGS. 12-13, the Stable Lasso coefficients are more stable than those of the Lasso coefficients, especially around the λ value selected by Stable Lasso. The heterogeneity among the Lasso coefficients indicates the instability or sensitivity to changes in the training samples. In some cases, a variable's coefficient changes signs along the path of coefficients, while in other cases a variable is switched on and off along the path of λ. The instability is undesirable for industrial applications, where collinearity among the predictors is typical.

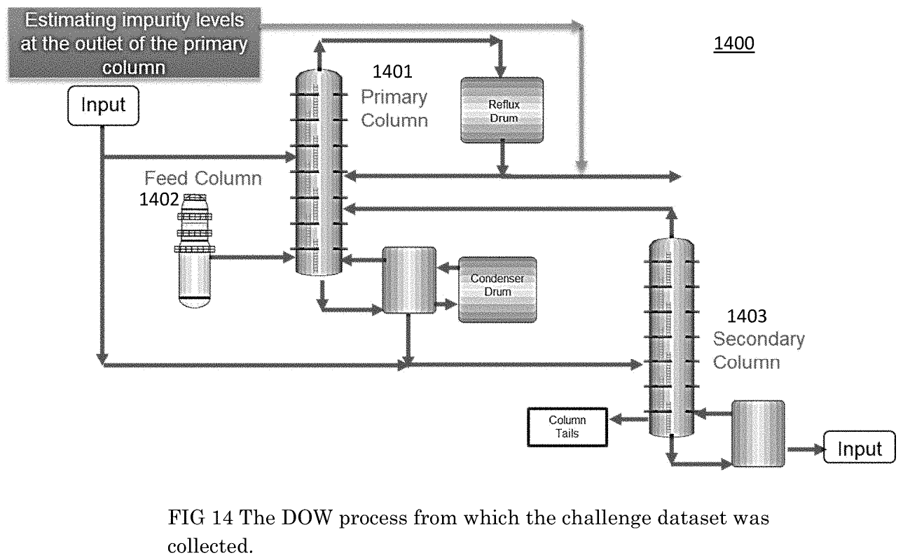

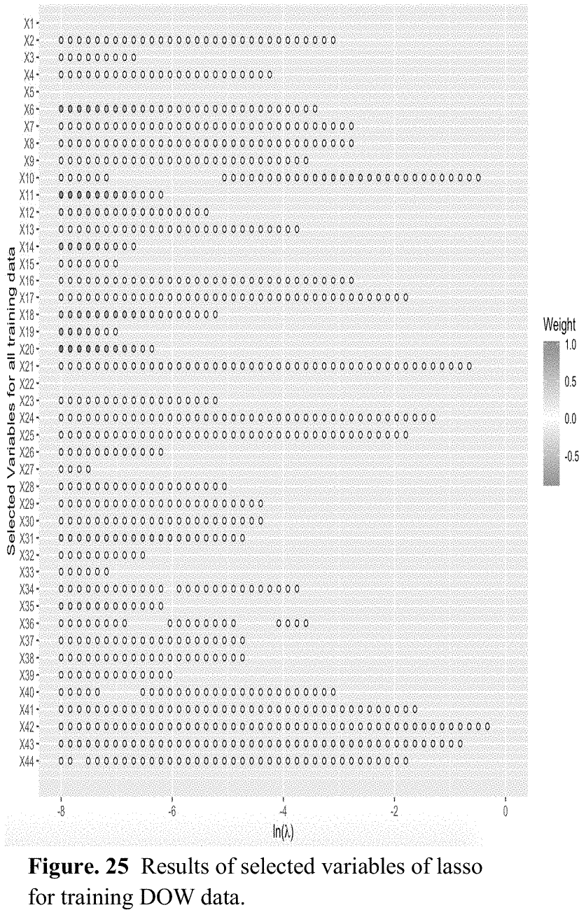

FIG. 14 illustrates a process 1400 from DOW Chemicals, that is used to produces a challenge dataset. The impurity in the product stream at the outlet of the primary column (PC) 1401 is a key quality indicator. This quality index is measured manually by lab tests. The process has a feed column (FC) 1402 upstream to the PC and a secondary column (SC) 1403 downstream. The control system collects measurements of forty variables in the process. In addition, four other measured or calculated variables from the PC 1401 are available for use in the model. While the challenges are multi-fold, from data pre-processing to final model building, the most important challenge is to select informative variables to predict impurity reliably and accurately. FIG. 25 shows the selected variables by Lasso for training DOW data.

Two datasets are provided, including one with over a year worth of data for model training, and the other one for validation of the trained model. The training set includes over 10,000 observations sampled hourly, while the validation set has over 6,000 observations. Pre-processing was conducted with process knowledge and modeling with partial least squares and least angle regression (LAR).

The temperature variables, x16 and x17, alternate between high values and low values almost periodically. When the low value periods of the two variables are joined sequentially in time, they represent ambient temperature that has clear seasonal changes. This confirms that the high value periods of the two variables reflect the process temperature when the sensor is in use, while the low values reflect ambient temperature when it is not in use. Therefore, two new variables, x16x17-High and x16x17-Low, are created to replace the recorded variables x16 and x17.

After the 6301st observations in the training dataset, there is an operation change in which Variable x8 (PC Reflux Drum Pressure) was reduced significantly, which deviated from the usual operations of the process. This practice is discarded in subsequent operations. Therefore, data after this point should not be used for training.

The impurity values show straight line segments for the whole dataset, which indicates that many of the observations are interpolated from measured data. These interpolated data are artificial and therefore, the corresponding observations are excluded from modeling.

Although only hourly process data are provided, the process variables are usually measured every few seconds. The hourly data show frequent missing values. Sometimes only one isolated observation is missing, while other times a consecutive segment of observations are missing. Judgment may be used to determine if the segments of missing data represent plant shutdown, of which the data should not be used for training or testing.

In this example, the datasets are processed according to the above findings to test the effectiveness of the Stable Lasso method for variable selection. To determine the optimal λ via CV, the data is divided into consecutive blocks of ten observations in each block, the blocks are then randomly drawn without replacement into seven folds. Each block belongs to one and only one fold.

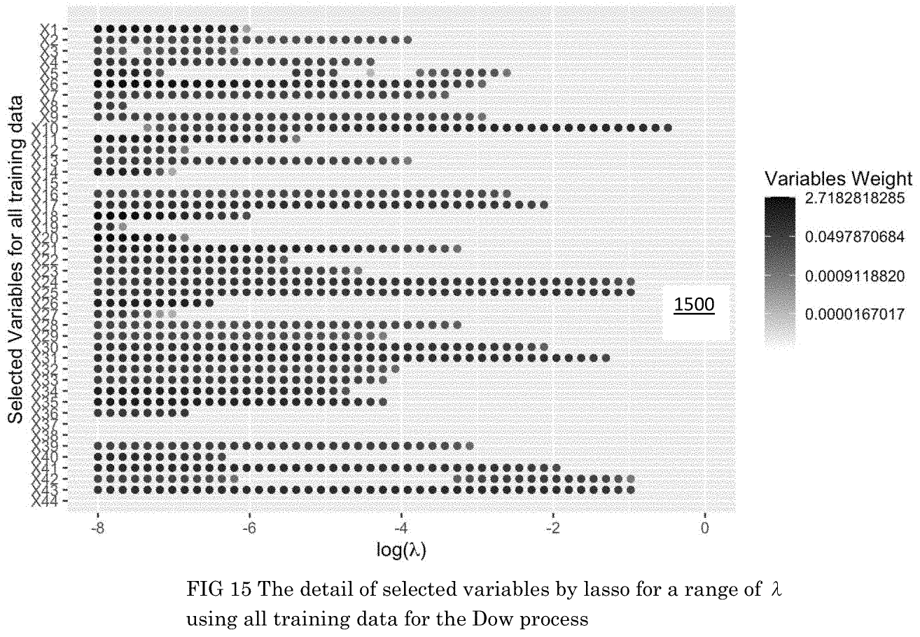

Stable Lasso results versus Lasso results are now described. The Stable Lasso and Lasso algorithms are tested for performance in selecting model structures for the challenge problem. The first step is to perform Lasso on a range of λ using all training data. FIG. 15 shows an example of variables 1500 selected by Lasso for a range of λ using all training data from the challenge data. The selections of several variables are discontinuous. For a given λ, the estimated coefficients β₀^{N} are used in the Stable Lasso algorithm.

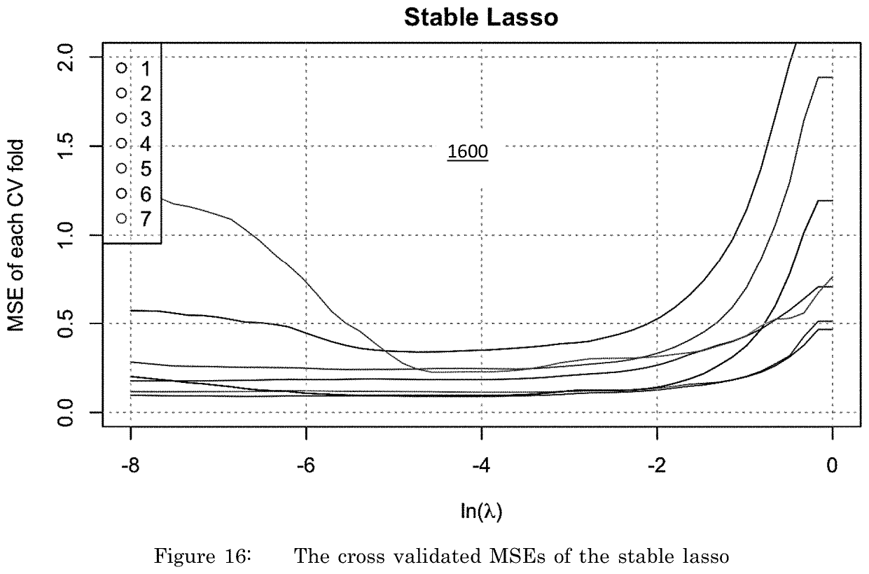

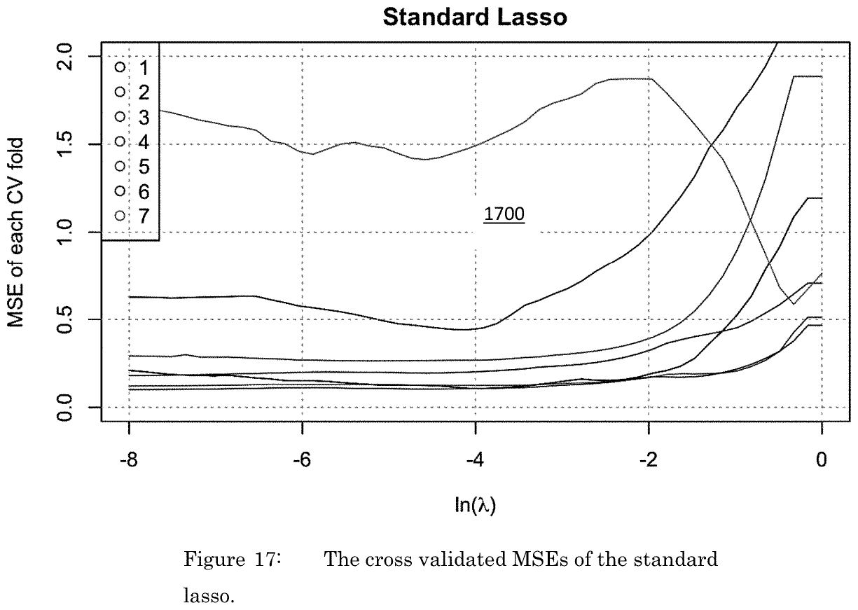

FIG. 16 shows a graph 1600 of an example of cross validated MSEs for the seven folds of Stable Lasso. FIG. 17 shows a graph 1700 of an example of cross validated MSEs for the seven folds of Stable Lasso. The Lasso MSEs of one CV fold are quite different from the rest, while the MSEs from Stable Lasso are more similar. In this case, averaging the MSEs across various CV folds can be dominated by this outlying fold.

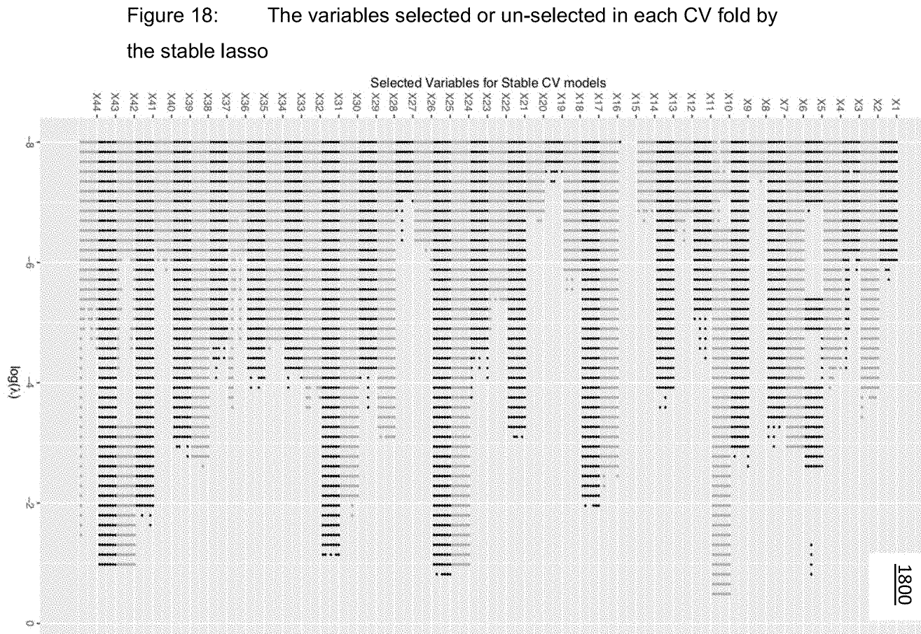

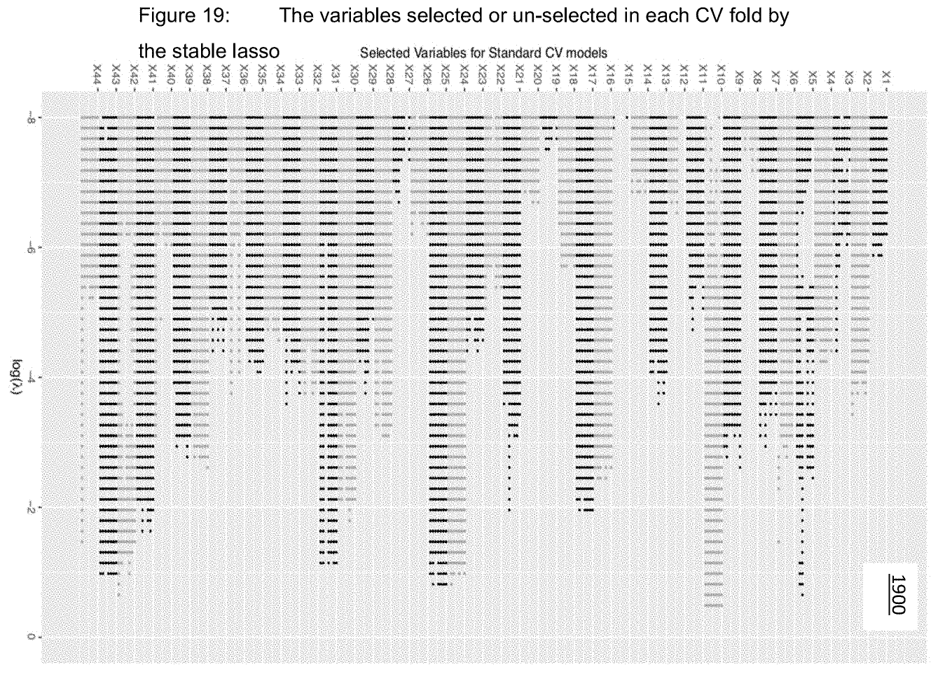

FIG. 18 shows an example of variables 1800 selected or un-selected by Stable Lasso in each CV fold. FIG. 19 shows an example of variables 1900 selected or un-selected by Lasso in each CV fold. Comparing the results in FIGS. 18-19, the stability and continuity of selected variables in Stable Lasso is much improved over standard Lasso.

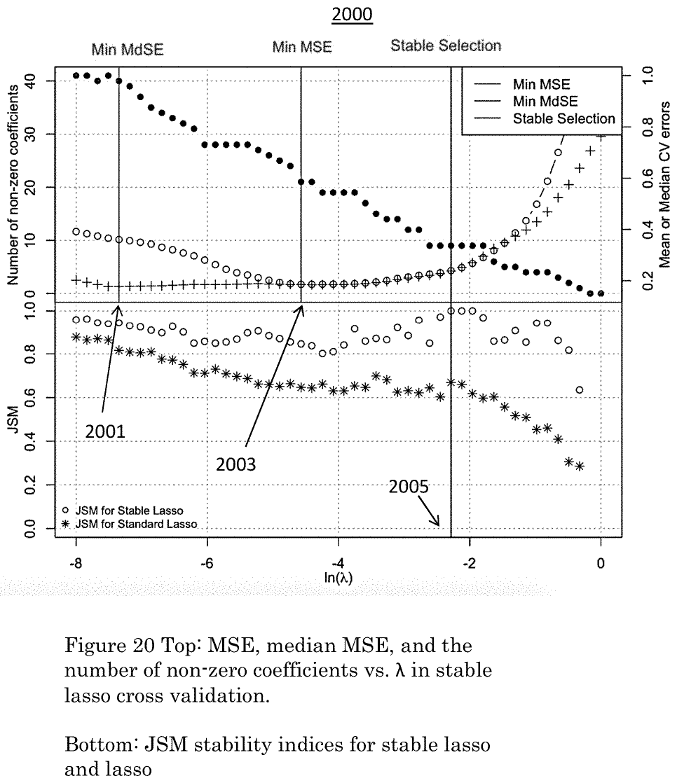

FIG. 20 shows a graph 2000 of an example JSM stability index for Stable Lasso and Lasso for the seven CV folds and an example of the coefficients of the model by the stable selection criterion. FIG. 20 also depicts the cross validated MSE, median MSE, and the number of non-zero coefficients for the case of Stable Lasso. The Stable Lasso algorithm leads to more stable structures across CV folds than standard Lasso. The vertical lines show the λ values selected by the criteria of minimum MSE 2001, minimum MdSE 2003, and balanced stable selection 2005. The stable selection criterion finds a λ that balances between stability and small MSE values.

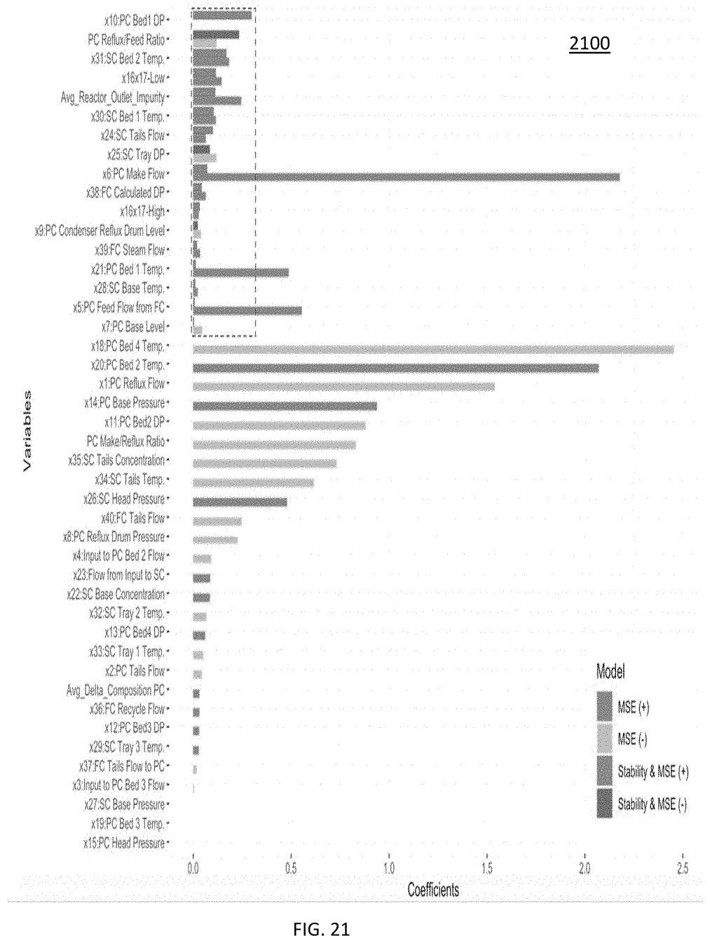

FIG. 21 depicts an example 2100 of the coefficients of the model by the stable selection criterion and those based on CV MSE. The variables are rank-ordered by the magnitude of the coefficients of the model by the stable selection criterion, then rank-ordered by the magnitude of the coefficients of the model by the MSE criterion. While the chosen λ values achieve similar cross-validated MSEs, several observations can be made.

The model by the stable selection criterion uses much smaller coefficients while achieving similar MSEs. The model selected by MSE-only has excessively large positive and negative coefficients, which implies that they largely cancel each other. The downside of a model like this is inflated variance of the predictions. This is verified when the models are tested on the validation dataset.

Variable x10:PC Bed1 Differential Pressure has the largest coefficient in the stable selection model, but it has a zero coefficient in the model based on MSE only. The differential pressure is the difference between the pressures at the bottom of Bed1 and the pressures at top of Bed1. High deferential pressure implies that the feed rate is high. In this case the process could overload and be unable to make the desired separation, causing the impurity to be high. Therefore, this variable may be important for predicting impurity.

The two largest coefficients in the model by MSE-only are Variables x18:PC Bed4 Temperature and x20:PC Bed2 Temperature, but their signs are opposite. This is an indication that they cancel each other since they are positively correlated. The stable selection model does not pick these variables. On the other hand, neither models pick Variable x19:PC Bed3 Temperature. Both models agree that Variables x15:PC Head Pressure and x27:SC Base Pressure are not picked.

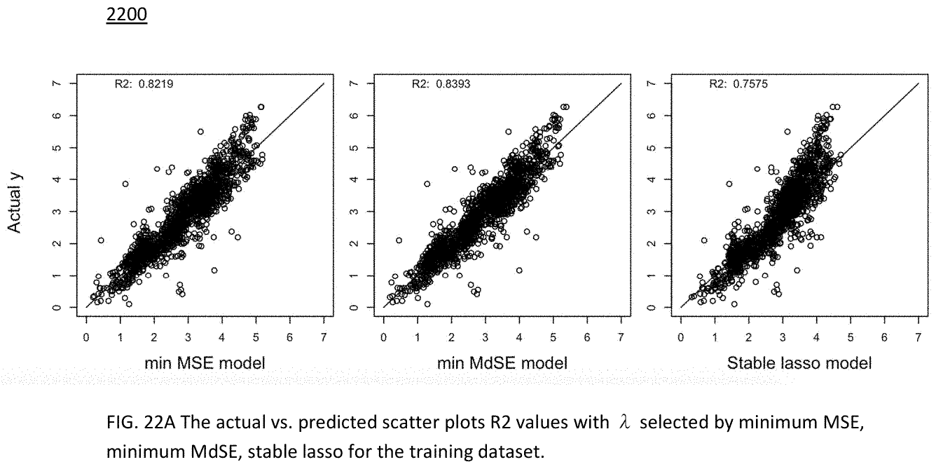

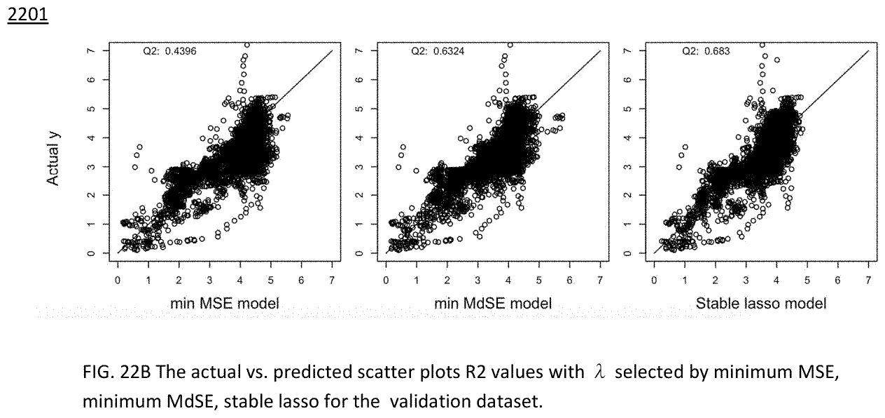

To test how well the models from these selection criteria perform on predictions, the resulting models are applied to the validation dataset. FIG. 22A depicts an example of scatter plots 2200 and correlations of actual vs. predicted values on the training dataset with R2 values selected by minimum MSE, minimum MdSE, and the stable Lasso for the training dataset. FIG. 22B also depicts an example scatter plots 2201 and correlations of actual vs. predicted values on the training dataset with O2 values selected by minimum MSE, minimum MdSE, and the stable Lasso for the validation dataset. The model by the stable selection criterion produces nearly the same the training errors but with much fewer variables selected. This parsimonious model yields significantly higher prediction accuracy on the validation dataset than the models by MSE and MdSE with much more variables.

As shown above, the Stable Lasso algorithm produces stable model structures in CV for Lasso modelling. The Stable Lasso revises the Lasso objective for each CV fold to penalize deviations from the model structure using all data. In addition, the Stable Lasso uses CV errors jointly with a stability measure to select a stable model with near minimum CV errors. The heterogeneity of the model structures during the CV step is greatly reduced, as is demonstrated using data from an industrial boiler process to predict NOx emissions. The improved stability with Stable Lasso can be readily adopted to real-time applications, where new data are augmented to update the model.

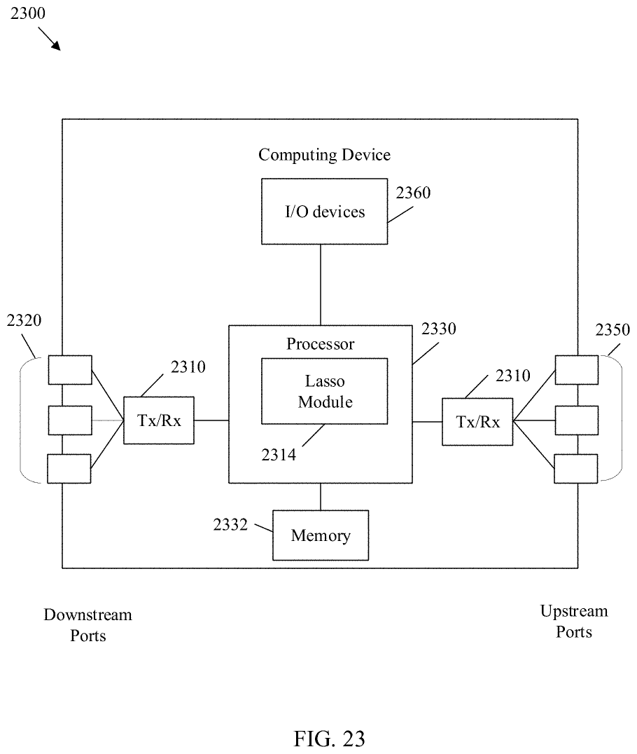

FIG. 23 is a schematic diagram of an example computing device 2300 configured to perform the example mechanisms described herein. The computing device 2300 comprises downstream ports 2320, upstream ports 2350, and/or transceiver units (Tx/Rx) 2310, including transmitters and/or receivers for communicating data upstream and/or downstream over a network. The computing device 2300 also includes a processor 2330 including a logic unit and/or central processing unit (CPU) to process the data and a memory 2332 for storing the data. The computing device 2300 may also comprise electrical, optical-to-electrical (OE) components, electrical-to-optical (EO) components, and/or wireless communication components coupled to the upstream ports 2350 and/or downstream ports 2320 for communication of data via electrical, optical, or wireless communication networks. The computing device 2300 may also include input and/or output (I/O) devices 2360 for communicating data to and from a user. The I/O devices 2360 may include output devices such as a display for displaying video data, speakers for outputting audio data, etc. The I/O devices 2360 may also include input devices, such as a keyboard, mouse, trackball, etc., and/or corresponding interfaces for interacting with such output devices.

The processor 2330 can be implemented by hardware and software. The processor 2330 may be implemented as one or more CPU chips, cores (e.g., as a multi-core processor), field-programmable gate arrays (FPGAs), application specific integrated circuits (ASICs), and digital signal processors (DSPs). The processor 2330 is in communication with the downstream ports 2320, Tx/Rx 2310, upstream ports 2350, and memory 2332. The processor 2330 comprises a Lasso module 2314. The Lasso module 2314 may implement any method/mechanism described herein. For example, the Lasso module 2314 can employ a CV in conjunction with a stabilization mechanism to create stable Lasso based machine learning model, for example to select predictive variables based on an industrial data set. Hence, Lasso module 2314 causes the computing device 2300 to provide additional functionality and/or flexibility performing machine learning. As such, Lasso module 2314 improves the functionality of the computing device 2300 as well as addresses problems that are specific to artificial intelligence and related arts. Further, Lasso module 2314 effects a transformation of the computing device 2300 to a different state. Alternatively, the Lasso module 2314 can be implemented as instructions stored in the memory 2332 and executed by the processor 2330 (e.g., as a computer program product stored on a non-transitory medium).

The memory 2332 comprises one or more memory types such as disks, tape drives, solid-state drives, read only memory (ROM), random access memory (RAM), flash memory, ternary content-addressable memory (TCAM), static random-access memory (SRAM), etc. The memory 2332 may be used as an over-flow data storage device, to store programs when such programs are selected for execution, and to store instructions and data that are read during program execution.

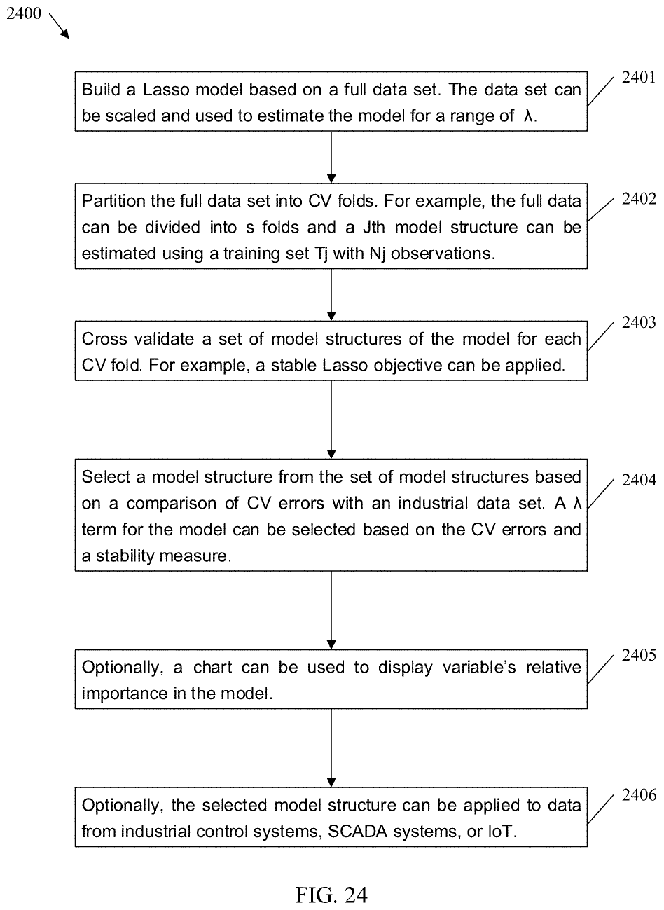

FIG. 24 is a flowchart of an example method 2400 of stabilization enhanced CV for Lasso models for selection of predictive variables. The method 2400 can be used to build a Lasso and/or a Lasso family model at step 2401. Specifically, the Lasso model is built based on a full data set, which may be denoted as training data and can be denoted mathematically as {xₖ}ₖ₌₁^{N}. The full data set can be scaled to a zero mean and unit variance. β₀^{N}=0 due to the zero-mean scaling. Further, the full data set to estimate the model β_{λ}^{N} according to Equation (3) for a range of λ. β₀^{N}=0 due to the zero-mean scaling. λ is a regularization parameter/tuning parameter used by the Lasso model. The model can be built with a grid of λ terms based on the full data set. The model may comprise one or more collinear parameters, for example when the full data set is industrial data.

At step 2402, the full data set is partitioned into CV folds. For example, the full data set can be divided into s folds to support performance of CV. A J^{th} model structure can be estimated using a training set Tj with Nj observations. The remainder of the full data set can be denoted as a J^{th} validation set Vj. Tj may include all observations except for Vj.

At step 2403, a set of model structures of the model are cross validated for each CV fold while penalizing deviations from the model to determine CV errors. For example, a stable Lasso objective can be applied according to:

$${β}_{λ}^{{N}_{J}} arg {min}_{β} \frac{1}{2 {N}_{J}} {\sum }_{k ∈ {T}_{J}} {( {y}_{k} - {B}_{0} - {x}_{k}^{T} β )}^{2} + λ {‖ β - {β}_{λ}^{N} ‖}_{1} .$$

Cross validating the set of model structures may comprise calculating CV errors on a validation set using β_{λ}^{N}^{_{J}}. This process may diminish heterogeneity of the set of model structures, which may increase model stability, for example when the model comprises one or more collinear parameters. The MSE and/or MdSE can be calculated on the validation set Vj using β_{λ}^{N}^{ⱼ}.

At step 2404, a model structure is selected from the set of model structures based on a comparison of CV errors, for example with an industrial data set. The CV errors may be determined based on an MSE and/or an of MdSE. Selecting the model structure may comprise selecting a λ term for the model based on the CV errors and a stability measure, such as a JSM. Selecting the model structure may comprise choosing a λ that results in a minimum MSE and/or a minimum MdSE. Selecting the model structure and/or λ may comprise choosing a midpoint of a most stable region of λ that provides most optimal CV errors. A most stable region of λ may be a region of multiple consecutive λ values that lead to the same sparsity. Selecting the model structure may further comprise selecting predictive variables for the model from a set of candidate predictors. For example, selecting the model structure may comprise selecting coefficients from β_{λ}^{N} as the model structure. In a specific example, selecting the model structure predicts key variables in a manufacturing system, a service system, or a product development process. Step 2404 applies an improved approach of using objective Equation (4) for CV and a balanced criterion between MSE and stability.

At step 2405, a chart is optionally displayed. For example, a flipped bar or line chart can be displayed to compare variables' importance in the model. The flipped bar or line chart can be used to visualize positive and negative numbers on a same side of an axis with different colors or symbols.

At step 2406, the selected model structure can be applied to data from industrial control systems, supervisory control and data acquisition (SCADA) systems, or industrial internet of things (IoT) devices.

While various aspects have been shown and described, modifications thereof can be made by one skilled in the art without departing from the spirit and teachings of the disclosure. The aspects described herein are exemplary only, and are not intended to be limiting.

What is claimed is:

1. A method of building an inferential sensor for a process comprising the steps of:
building a model based on a full data set from the process;
partitioning the full data set into cross validation (CV) folds;
cross validating a set of model structures of the model for each CV fold while penalizing deviations from the model to determine CV errors; and
selecting a model structure from the set of model structures based on a comparison of CV errors.

2. The method of claim 1, wherein the model is built with a grid of tuning parameter (λ) terms based on the full data set.

3. The method of claim 2, further comprising:
selecting a λ term for the model based on the CV errors and a stability measure.

4. The method of claim 3, wherein the stability measure is a Jaccard stability measure (JSM).

5. The method of claim 3, wherein the CV errors are determined based on an average of mean squares error (MSE) or an average of median squared errors (MdSE).

6. The method of claim 1, further comprising:
diminishing heterogeneity of the set of model structures during cross validation.

7. The method of claim 6, wherein diminishing heterogeneity increases model stability when the model comprises one or more collinear parameters.

8. The method of claim 1, wherein the model comprises collinear parameters.

9. The method of claim 1, wherein selecting the model structure further comprises selecting predictive variables for the model from a set of candidate predictors.

10. The method of claim 3, wherein building the model based on the full data set further comprises:
scaling the full data set to a zero mean and unit variance; and
using the full data set to estimate the model for a range of λ.

11. The method of claim 10, wherein partitioning the full data set into CV folds further comprises:
dividing the full data set in s folds; and
estimating a j^{th} model structure using a training set Tⱼ with Nⱼ observations.

12. The method of claim 11, wherein cross validating the set of model structures further comprises:
applying a stable least absolute shrinkage and selection operator (Lasso) objective according to:
$${β}_{λ}^{{N}_{J}} = arg {min}_{β} \frac{1}{2 {N}_{J}} {\sum }_{k ∈ {T}_{J}} {( {y}_{k} - {β}_{0} - {x}_{k}^{T} β )}^{2} + λ {‖ β - {β}_{λ}^{N} ‖}_{1} .$$

13. The method of claim 12, wherein cross validating the set of model structures further comprises calculating CV errors on a validation set using β_{λ}^{N}^{_{J}}.

14. The method of claim 13, wherein selecting the λ term for the model further comprises:
choosing a λ that results in a minimum mean squares error (MSE) or a minimum median squared errors (MdSE).

15. The method of claim 14, wherein selecting the model structure comprises selecting coefficients from β_{λ}^{N} as the model structure.

16. The method of claim 13, wherein selecting the λ term for the model further comprises:
choosing a stable region where the JSM is as close to one as possible, while the MSE or the MdSE are almost the same as their minimum values.

17. The method of claim 16, wherein
a most dominant structure among all distinct structures that attain a highest JSM value is chosen when the highest JSM value is obtained with multiple consecutive λ values, and wherein final model parameters with a most dominant stable model structure are re-estimated with a cross-validated ridge regression to further improve accuracy.

18. The method of claim 1, wherein,
selecting the model structure predicts key variables in a manufacturing system, a service system, or a product development process.

19. The method of claim 1, further comprising:
displaying a flipped bar or line chart to compare variables' importance in the model, wherein the flipped bar or line chart visualizes positive and negative numbers on a same side of an axis with different colours or symbols.

20. The method of claim 1, further comprising:
applying the selected model structure to data from industrial control systems, supervisory control and data acquisition (SCADA) systems, or industrial internet of things (IoT).

21. A system for developing a model of a process, the system comprising
a processor; and
a memory, wherein the memory stores a selection application, and wherein the selection application, when executed on the processor, configures the processor to:
access a full data set;
build a model based on the full data set;
partition the full data set into cross validation (CV) folds;
cross validate a set of model structures of the model for each CV fold while penalizing deviations from the model to determine CV errors; and
select a model structure from the set of model structures based on a comparison of CV errors.

22. The system of claim 21, wherein the processor is further configured to:
build the model with a grid of tuning parameter (λ) terms based on the full data set.

23. The system of claim 22, wherein the processor is further configured to:
select a λ term for the model based on the CV errors and a stability measure.

24. The system of claim 23, wherein the stability measure is a Jaccard stability measure (JSM).

25. The system of claim 23, wherein the CV errors are determined based on an average of mean squares error (MSE) or an average of median squared errors (MdSE).

26. The system of claim 21, wherein the model is built by least absolute shrinkage and selection operator (Lasso).
